(19) United States
(12) Patent Application Publication
(10) Pub. No.: US 2018/0120009 A1
(43) Pub. Date: May 3, 2018

(54) SYSTEM AND METHOD FOR DYNAMIC MECHANICAL POWER MANAGEMENT

(71) Applicant: Trienco Ltd., Gedera (IL)

(72) Inventor: Dori Hershgal, Gedera (IL)

(21) Appl. No.: 15/571,323

(22) PCT Filed: May 5, 2016
(86) PCT No.: PCT/IL2016/050473

§ 371 Date: Nov. 2, 2017

Related U.S. Application Data
(60) Provisional application No. 62/157,493, filed on May 6, 2015.
(60) Provisional application No. 62/331,597, filed on May 4, 2016.

(51) Int. Cl. F25B 49/02; F01D 15/10; F01K 5/00; F25B 11/02; F25B 23/00; F25B 25/00; F25B 27/00

(52) U.S. Cl. CPC F25B 49/02; F01D 15/10; F01K 5/00; F25B 11/02; F05D 2260/40; F25B 25/005; F25B 27/00; F05D 2220/72; F05D 2220/76; F25B 23/006

(57) ABSTRACT

Power management system including a mechanical power source generating torque, a variable mechanical power load, a generator/motor and a power controller. The variable mechanical power load is mechanically coupled with the mechanical power source and with the generator/motor such that torque is transferred therebetween. The coupled with the mechanical power source and with the generator/motor. The generator/motor is operative to operate as a mechanical power generator converting electrical power into mechanical power, and as an electric power generator converting mechanical power into electrical power. The power controller directs the generator/motor to operate as one of a mechanical power generator and an electrical power generator, to maintain a power balance between the mechanical power source, the variable mechanical power load and the generator/motor and such that the angular velocity of each of the mechanical power source, the variable mechanical power load and the generator/motor is maintained at their respective operational velocities.

### FIELD OF THE DISCLOSED TECHNIQUE

The disclosed technique relates to energy efficiency and savings for power systems in general, and to systems methods for dynamic mechanical power management, in particular.

### BACKGROUND OF THE DISCLOSED TECHNIQUE

Heat Pump systems, such as Heating, Ventilating, and Air-Conditioning (HVAC) systems are designed to meet peak heating or cooling loads requirements that generally occur only 1% to 2.5% of the time (i.e., on the order of tens of hours a year). The rest of the year, only light to medium capacities are required. As known in the art, depending on local climate, up to approximately 40% of the time, a cooling system would operate up to approximately 50% of full capacity thereof. In general, it is the objective of the HVAC control system that the HVAC system operates properly, reliably, and efficiently saving the driving energy usage (e.g., optimizing HVAC system electricity usage).

Similarly, when a Heat Pump system is driven by low grade heat (e.g., thermal solar heat or recovered process heat), the maximum driving energy is typically also required for only several tens of hours per year. The rest of the time, the heat pump is required to operate at only light to medium capacity. Therefore, depending on local climate, approximately up to 50% of a process recovered heat source or the thermal solar energy collected by installed solar field is not being used for up to approximately 40% of the time. Usually, this excess amount of thermal energy is temporarily diverted to an insulated heat storage for later use, or intentionally wasted by the control system, although cooling or heating requirements are achieved. For example, in order to control the cooling requirements at a site operated by a known in the art solar driven absorption system, the energy generated by the heat source is temporarily stored in external insulated heat storage or regulated to handle the cooling requirement. As a result, the cooling requirement is indeed satisfied, but at the expense of storing or wasting any captured energy which is not immediately utilized.

A known in the art system for converting heat into mechanical energy is the closed Rankine Cycle (RC). Reference is now made to FIG. 1, which is a schematic illustration of a RC system, generally referenced 10, which is known in the art. RC System 10 includes a boiler 12, a turbine 14, a condenser 16 and a pump 18. Turbine 14 is fluidally coupled with boiler 12 and with condenser 16 (e.g., via pipes in which a fluid can flow). Pump 18 is fluidally coupled with condenser 16 and with boiler 12 (e.g., also via pipes or conduits in which a fluid can flow). The term ‘fluidally coupled’ herein relates to coupling between elements such that fluid can flow from one element to the other.

Boiler 12 evaporates a motive fluid (e.g., water) into vapors. The vapors (e.g., steam) flow to turbine 14 which rotates and generates mechanical power. The vapors from turbine 14 flow to condenser 16, which transfers heat to the environment, condenses the vapors and changes the state thereof back to liquid. Pump 18 pumps the motive fluid back to boiler 12.

The mechanical power generated by turbine 14 generally rotates a generator 20 either directly or via a transmission gear such as transmission gear 22. The turbine in systems such system 10, is typically designed to operate at relatively high pressures and temperatures to generate high power and are relatively expensive to manufacture and use. Generator 20 transforms the mechanical power into electrical power to provide electrical power to a grid or supply electric power to other systems such as heat pumps.

A known in the art system technique of providing power to (i.e., driving) a heat pump is to mechanically couple the heat pump compressor to the mechanical output of the turbine. Thus, the losses incurred when transforming the mechanical power into electrical power and back to mechanical power are avoided. More specifically the heat pump is mechanically coupled with the output of an Organic Rankine Cycle (ORC). The ORC is similar to the steam cycle power generation system described hereinabove in conjunction with FIG. 1, whereas an organic fluid is employed instead of water/steam as the motive fluid. Such organic fluids, known as refrigerants, generally operate at lower temperatures than water/steam to generate less power but at reduced costs. Such refrigerants are commercially available in the HVAC industry with appropriate thermodynamic and environmental properties. Furthermore, the high speed turbine may be replaced by a positive displacement compressor, modified by reversing its flow direction, known as “Expander” at lower cost than a turbine. An air-conditioning or refrigeration equipment can be driven with the power produced by the ORC system.

Reference is now made to FIG. 2, which is a schematic illustration of a system, generally referenced 50, in which a heat pump is driven by an ORC, which is known in the art. System 50 includes an ORC 52 and a heat pump 54. ORC 52 includes a boiler 56, an expander 58, a condenser 60 and a pump 62. Heat pump 54 includes condenser 60 (i.e., condenser 60 is common to both ORC 52 and heat pump 54), a compressor 64, an evaporator 66 and an expansion valve 68. System 50 further includes a mechanical coupler 70 such as a transmission gear.

In ORC 52, expander 58 is fluidally coupled with boiler 56 and with condenser 60 (e.g., via pipes or conduits in which a fluid can flow). Pump 62 is fluidally coupled with condenser 60 and with boiler 56 (e.g., also via pipes or conduits in which a fluid can flow). In heat pump 54, condenser 60 is fluidally coupled with compressor 64 and expansion valve 68. Evaporator 66 is also fluidally coupled with compressor 64 and expansion valve 68. Furthermore in system 50, expander 58 is mechanically coupled with compressor 64 via mechanical coupler 70.

In ORC 52, boiler 56 evaporates the fluid (e.g., a refrigerant) and creates vapors. The vapors flow through expander 58 which generates torque. The vapors discharged from expander 58 flow to condenser 60, which condenses the vapors back to fluid. Pump 62 pumps the fluid back to boiler 56. The mechanical torque generated by expander 58 rotates compressor 64 at an angular speed via mechanical coupler 70.

In heat pump 54, evaporator 66 absorbs heat from the environment and evaporates a refrigerant liquid to vapors. Compressor 64 compresses the refrigerant vapors to a high pressure which also results in an increase in the temperature of the refrigerant. The refrigerant than flows into condenser 60 which condenses the refrigerant (i.e., changes the state of the refrigerant from vapors to liquid). From condenser 60, the refrigerant liquid flows through expansion valve 68. Expansion valve 68 reduces the pressure of the refrigerant liquid to a temperature value in which the refrigerant can absorb heat from the environment and to evaporate in evaporator 66. In system 50, the fluid employed by ORC 52 and the refrigerant employed by heat pump 54 may be the same fluid or two different fluids. Furthermore, condenser 60 may include to different condensers for each of ORC 52 and heat pump 54.

U.S. Patent Application Publication No.: 2014/0075970 A1 to Benson, and entitled “Integrated Power, Cooling, and Heating Device and Method Thereof”, is directed to a heating, cooling, and power device and method utilizing a heat source to drive an electrical power generator and an air conditioning and heating system to provide power, and to heat or cool an environmentally controlled space. The heating, cooling, and power device includes a heat source, a heater, a speed control valve, a plurality of conduits that transport a working fluid, an expander, a shaft, a speed sensor, a controller, recuperators, a condenser, a plurality of valves, a heat exchanger, a clutch, an electric machine, and a fan.

The shaft is coupled to the expander, compressor, the electric machine, and to the clutch. The heater is coupled with the over-speed control valve through one of the conduits. In the heater, thermal energy from the heat source is transferred to the working fluid. The heated working fluid exits the heater and passes through the over-speed control valve toward the expander. The expander converts at least part of the thermal energy in the expansion of the working fluid into mechanical energy to drive the shaft. The shaft drives the compressor to compress the gaseous working fluid exiting from the heat exchanger. The speed sensor detects the speed at which the shaft or the expander rotates and sends information to the controller, which in turn applies speed control logic. The controller increases or decreases the rotational speed of the expander. The working fluid exits the expander and enters the recuperators, which in turn recapture unutilized heat from the working fluid. The working fluid then flows through a valve that is set to switch between heating and cooling modes into the condenser. The condenser condenses and cools the working fluid, which flows out of the condenser into the heat exchanger, which in turn evaporates the working fluid into a gas. The fan blows over the heat exchanger to cool the environmentally controlled space, in the cooling mode. The working fluid that exits the heat exchanger flows back through one of the values into the compressor. In the heating mode, working fluid from the heat exchanger enters the compressor, and mixes with working fluid leaving a recuperator.

The clutch disengages the expander from the shaft when heat is not available or expander function is not required. The electrical machine is configured either as an electric generator to convert the kinetic energy of the shaft to electricity, or as a motor to drive the shaft and the compressor when heat from the heat source is insufficient to drive the expander at a sufficient rate.

### SUMMARY OF THE PRESENT DISCLOSED TECHNIQUE

It is an object of the disclosed technique to provide a novel method and system for dynamic mechanical power management. In accordance with the disclosed technique, there is thus provided a power management system. The system includes a mechanical power source generating torque, a variable mechanical power load, a generator/motor and a power controller. The variable mechanical power load is mechanically coupled with the mechanical power source such that torque is transferred between the mechanical power source and variable mechanical power load. The generator/motor is mechanically coupled with the mechanical power source and the variable mechanical power load such that torque is transferred between the mechanical power source, the mechanical power load and the generator/motor. The coupled with the mechanical power source and with the generator/motor. The generator/motor is operative to operate as a mechanical power generator converting electrical power into mechanical power, and as an electric power generator converting mechanical power into electrical power. The power controller directs the generator/motor to operate as one of a mechanical power generator and an electrical power generator, to maintain a power balance between the mechanical power source, the variable mechanical power load and the generator/motor and such that the angular velocity of each of the mechanical power source, the variable mechanical power load and the generator/motor is maintained at their respective operational velocities.

### BRIEF DESCRIPTION OF THE DRAWINGS

The disclosed technique will be understood and appreciated more fully from the following detailed description taken in conjunction with the drawings in which:

FIG. 1 is a schematic illustration of a Rankine Cycle system which is known in the art;

FIG. 2, is a schematic illustration of a system in which a heat pump is driven by an Organic Rankine Cycle which is known in the art;

FIGS. 3A-3E, are schematic illustrations of a system for dynamic power management according to power supply level and power requirements level, constructed and operative in accordance with an embodiment of the disclosed technique;

FIG. 4 is a schematic illustration of a table depicting an exemplary logic by which a system according to the disclosed technique may operate, in accordance with another embodiment of the disclosed technique;

FIGS. 5A-5E are schematic illustrations of a variable flow compressor, an expander and a generator/motor, operative to be mechanically coupled such that they share a single common rotational shaft, in accordance with a further embodiment of the disclosed technique; and

FIG. 6 is a schematic illustration of a system, for dynamic mechanical power management, constructed and operative in accordance with another embodiment of the disclosed technique.

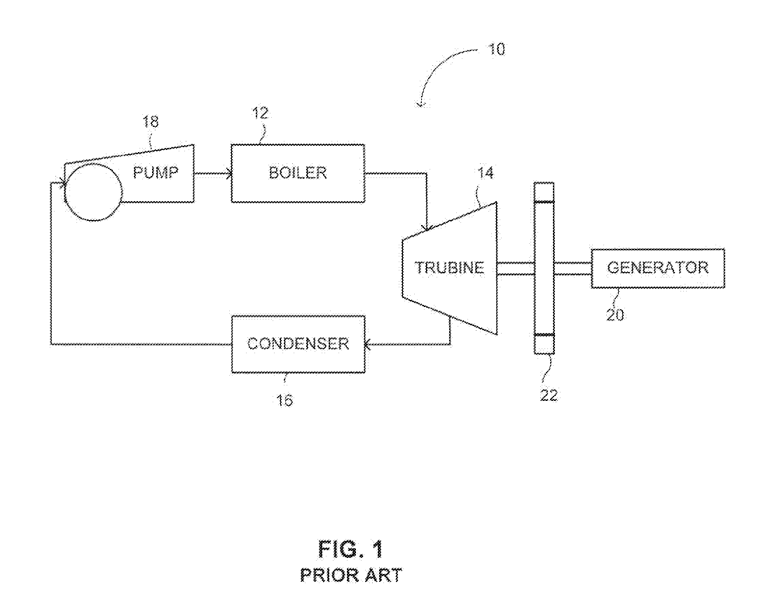

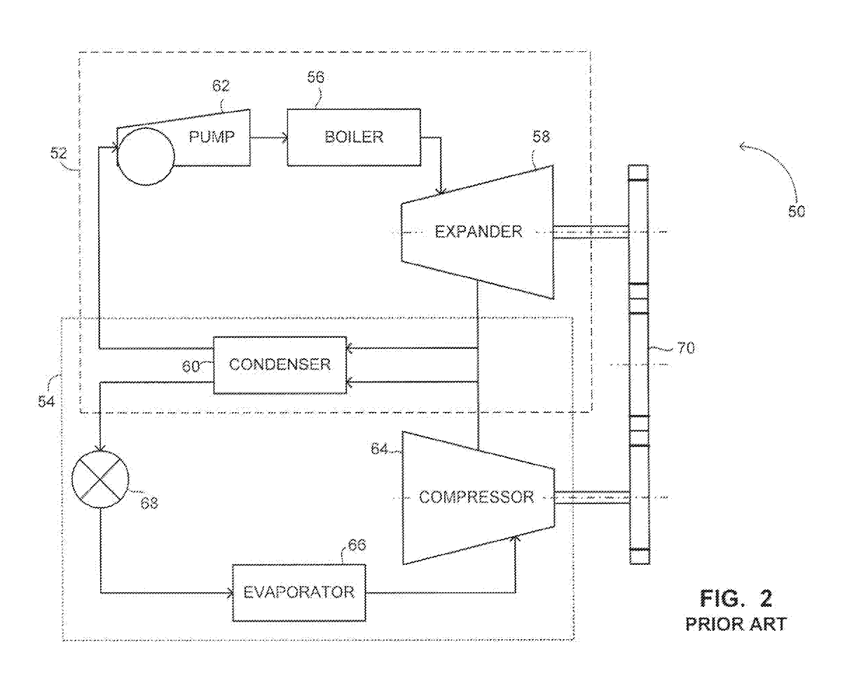

### DETAILED DESCRIPTION OF THE EMBODIMENTS

The disclosed technique overcomes the disadvantages of the prior art by providing a system and method for dynamic mechanical power management, according to power supply levels and power demand levels. According to the disclosed technique, a power balance is maintained between a mechanical power source, a mechanical power load and an electrical-mechanical power converted such as a generator/motor. The mechanical power load such as a heat pump, employs power generated by either a heat driven mechanical power source such as a Rankine cycle, or the electrical-mechanical power converted (i.e. operating as an electric driven mechanical power source such as an electric motor), or both, according to the power generated by the heat driven mechanical power source and the power requirements of the mechanical power load. Further according to the disclosed technique, the heat driven mechanical power source provides power to either the mechanical power load or to the electrical-mechanical power converted (i.e. operating as an electric generator), or to both the mechanical power load and the electrical-mechanical power converted (i.e. operating as an electric generator), according to the power generated by heat driven mechanical power source and the power requirements of the mechanical power load. Maintaining the power balance results in efficient energy utilization, which may also result in savings of cost. It is noted that in general, mechanical rotational power is determined by the torque times the angular velocity of a rotating body. In the context of this application, the terms ‘power’, ‘mechanical rotational power’ may be employed interchangeable. It is further noted that for the purpose of the explanation which follows, the heat driven mechanical power source is exemplified as a Rankine cycle and the mechanical power load is exemplified as a heat pump, which is required to meet heating or cooling requirements.

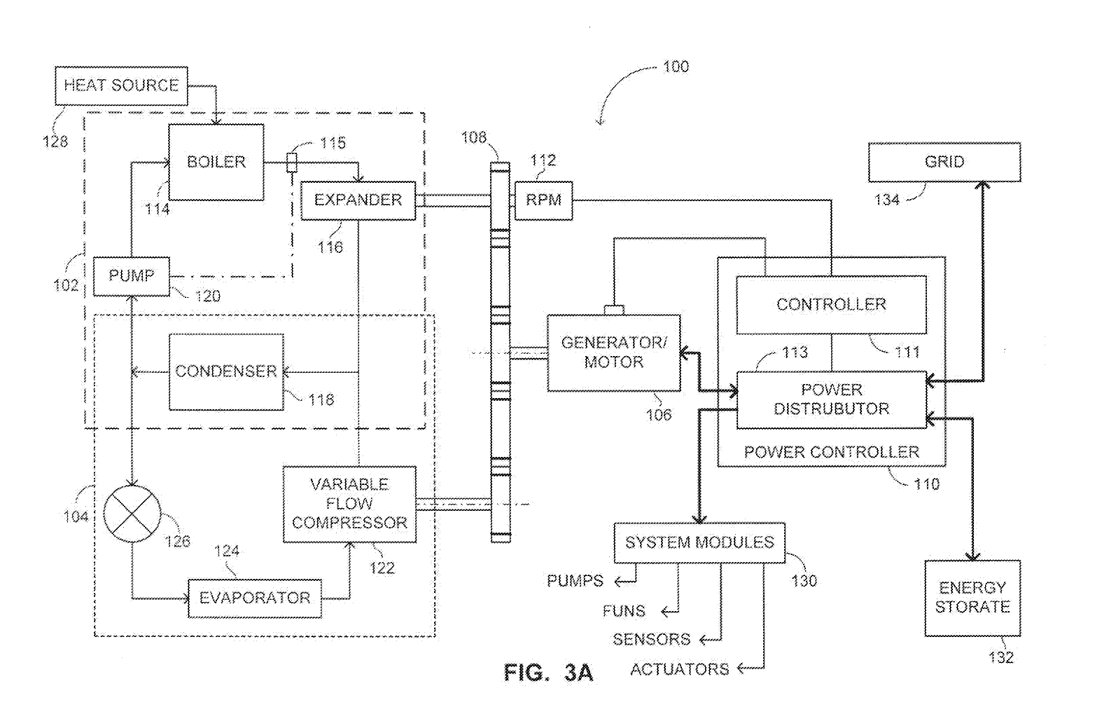

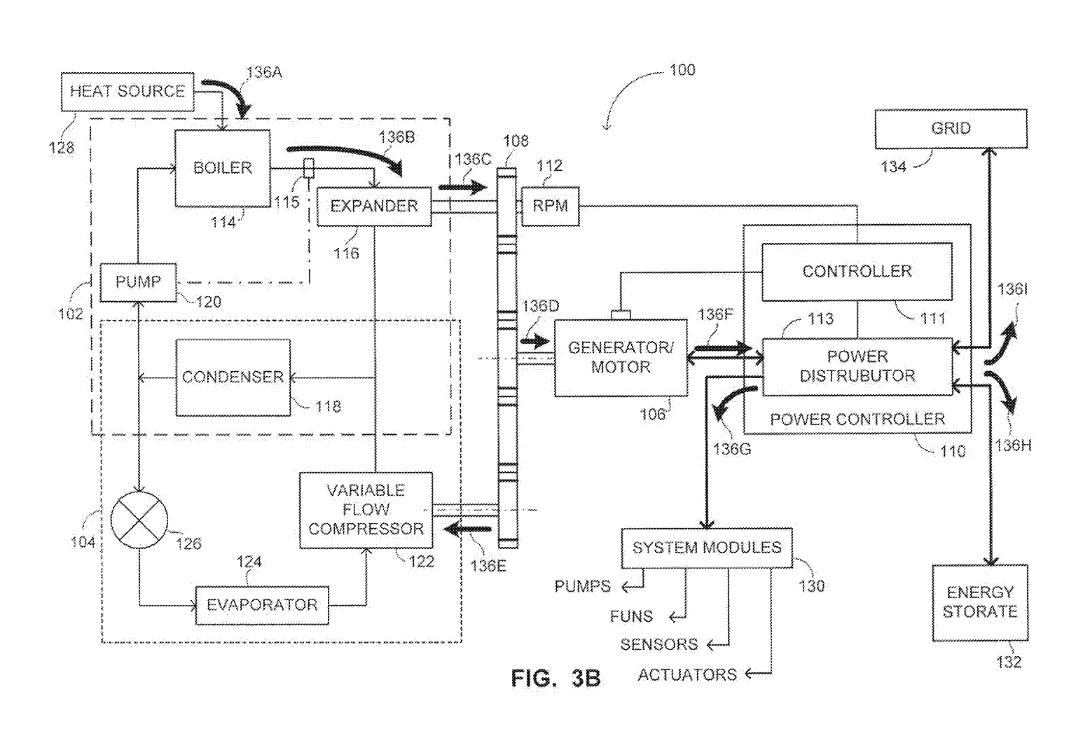

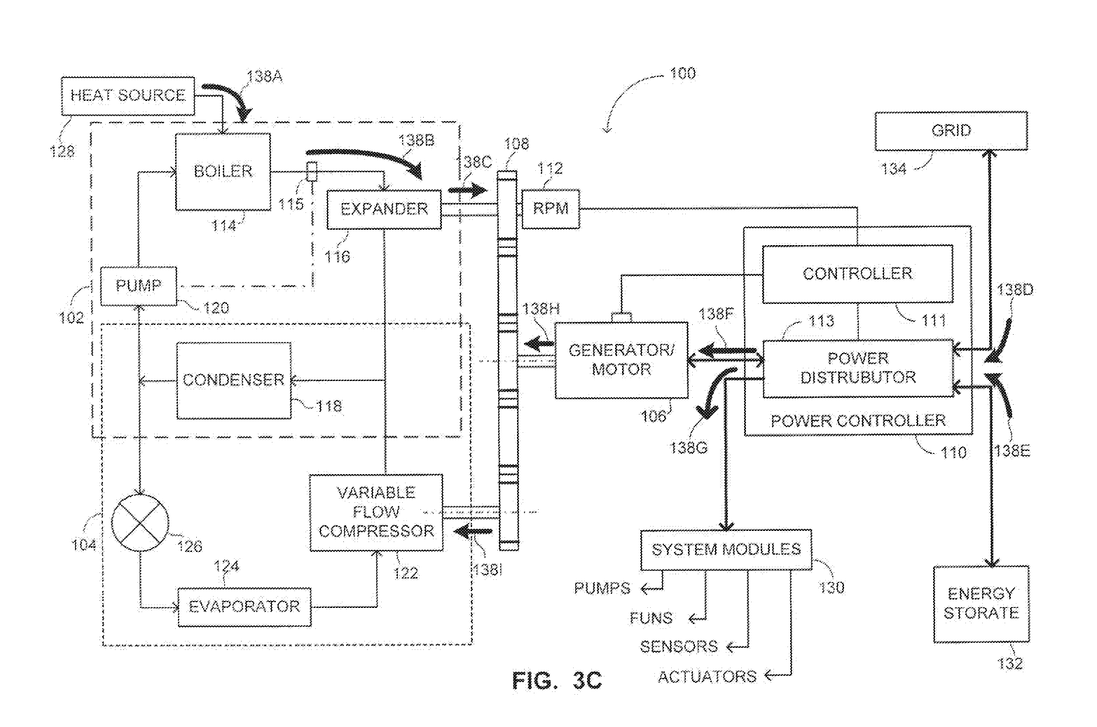

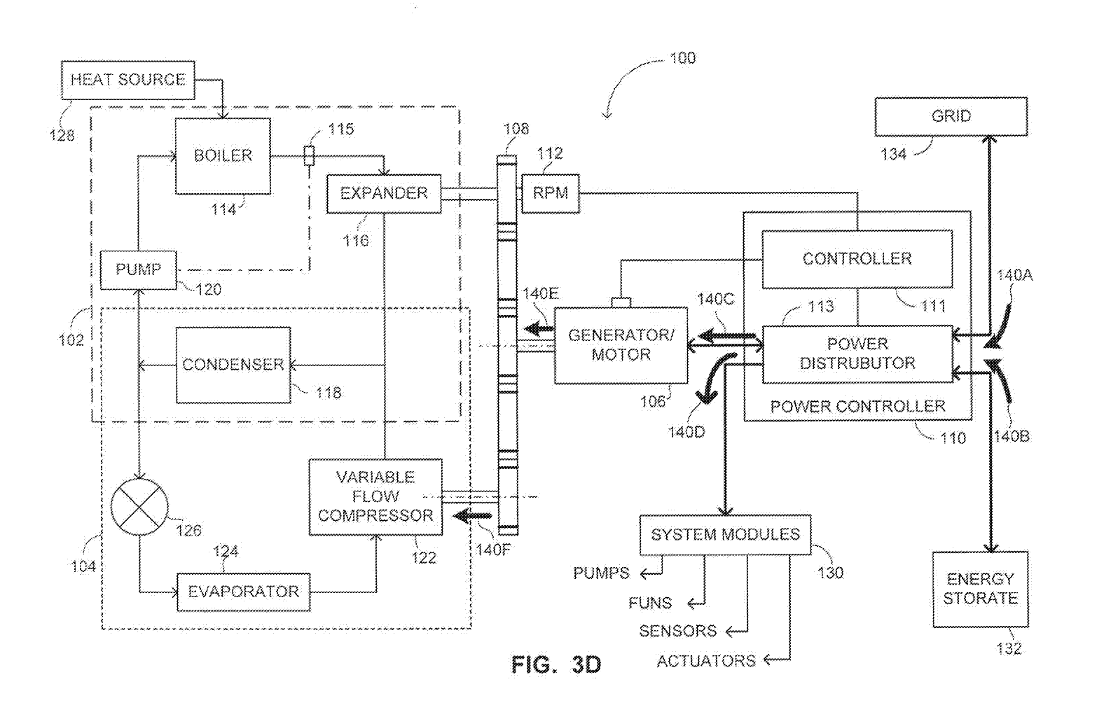

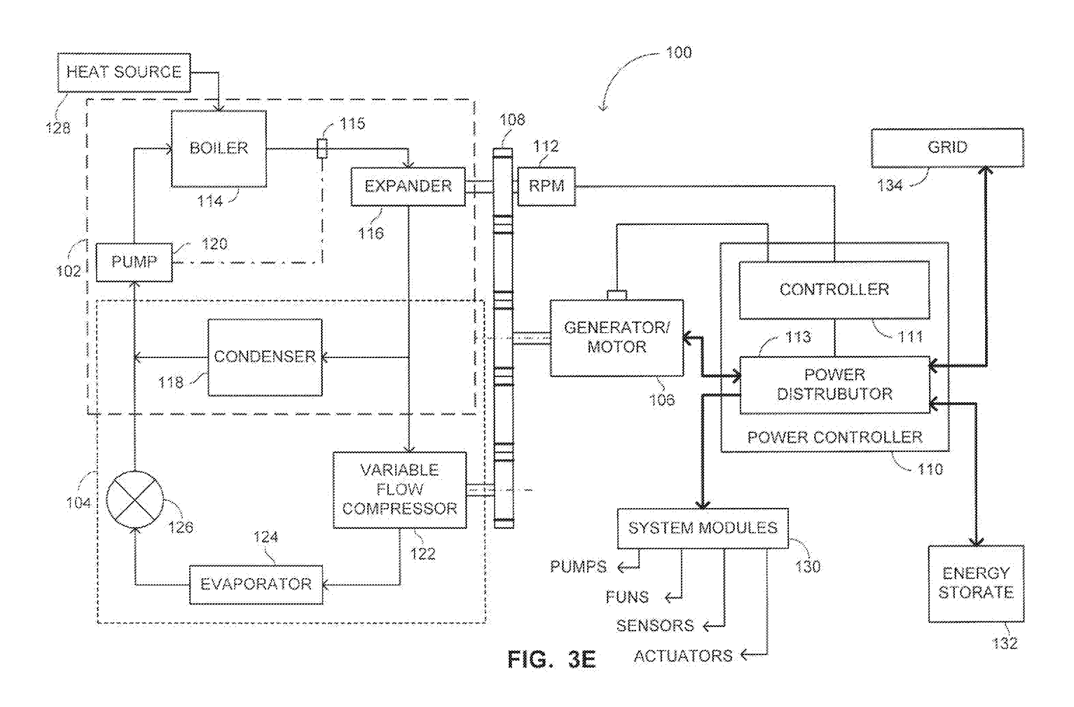

Reference is now made to FIGS. 3A-3E, which are schematic illustrations of a system, generally referenced 100, for dynamic mechanical power management, constructed and operative in accordance with an embodiment of the disclosed technique. System 100 includes an ORC 102, a heat pump 104, a generator/motor 106, a mechanical coupler 108, a power controller 110, an angular velocity sensor 112 (demarked ‘RPM’ in FIGS. 3A-3e) and a sensing bulb 115. ORC 102 includes a boiler 114, an expander 116, a condenser 118 and a pump 120. Heat pump 104 includes condenser 118 (i.e., condenser 118 is common to both ORC 102 and heat pump 104), a variable flow compressor 122, an evaporator 124 and an expansion valve 126. Power controller 110 includes a controller 111 and a power distributor 113. It is noted that system 100 may also include internal heat exchangers for heat recovery, lubrication and oil separation means, liquid receivers/dryers and other various known in the art features, which are not depicted in FIGS. 3A-3E for simplicity.

In RC 102, expander 116 is fluidally coupled with boiler 114 and with condenser 118 (e.g., via pipes or conduits in which a fluid can flow). Pump 120 is fluidally coupled with condenser 118 and with boiler 114 (e.g., also via pipes in which a fluid can flow). In heat pump 104, condenser 118 is fluidally coupled with variable flow compressor 122 and expansion valve 126. Evaporator 124 is also fluidally coupled with variable flow compressor 122 and expansion valve 126. Furthermore in system 100, mechanical coupler 108 mechanically couples expander 116, variable flow compressor 122 and generator/motor 106 such that mechanical power is transferred therebetween. Furthermore, controller 111 is coupled (e.g., by wire or wirelessly) with generator/motor 106, with angular velocity sensor 112 and with power distributor 113. Sensing bulb 115 is coupled with pump 120. Power distributor 113 is electrically coupled with generator motor 106, system modules 130, energy storage 132 and electric grid 134. It is noted that the term ‘electrically coupled’ relates herein to coupling between elements such that electric power can be transferred from one element to the other.

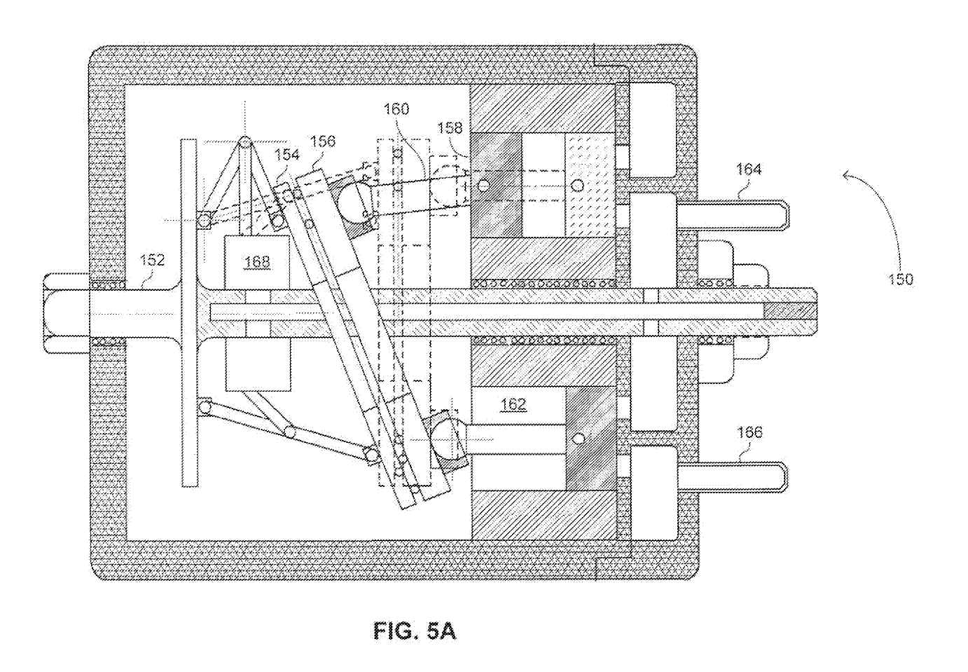

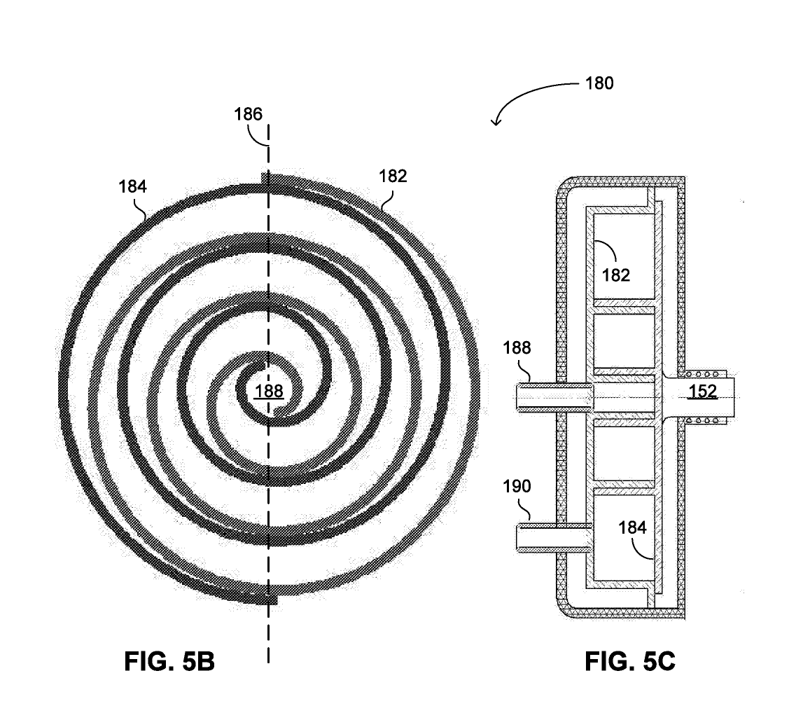

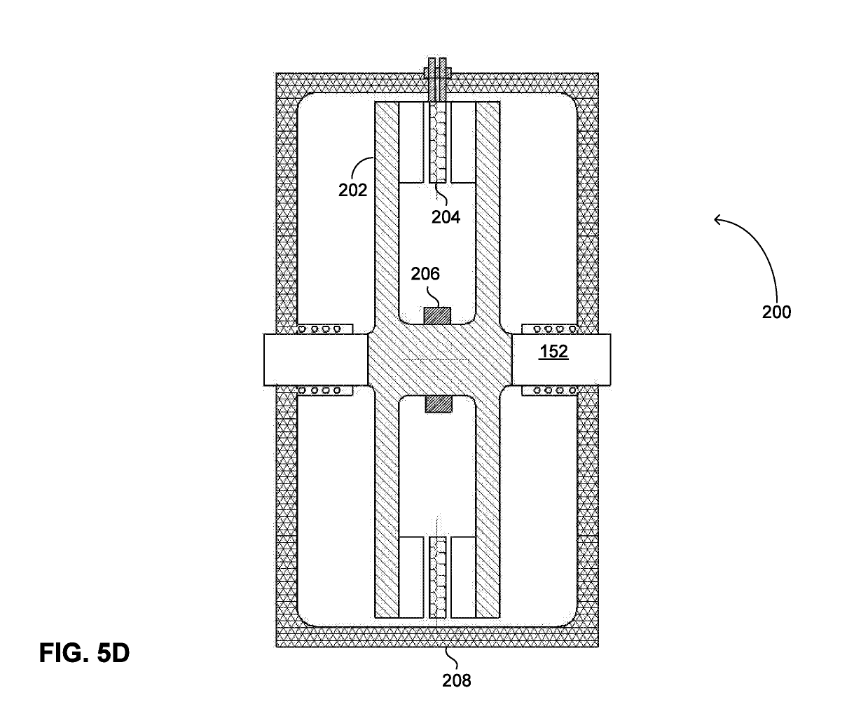

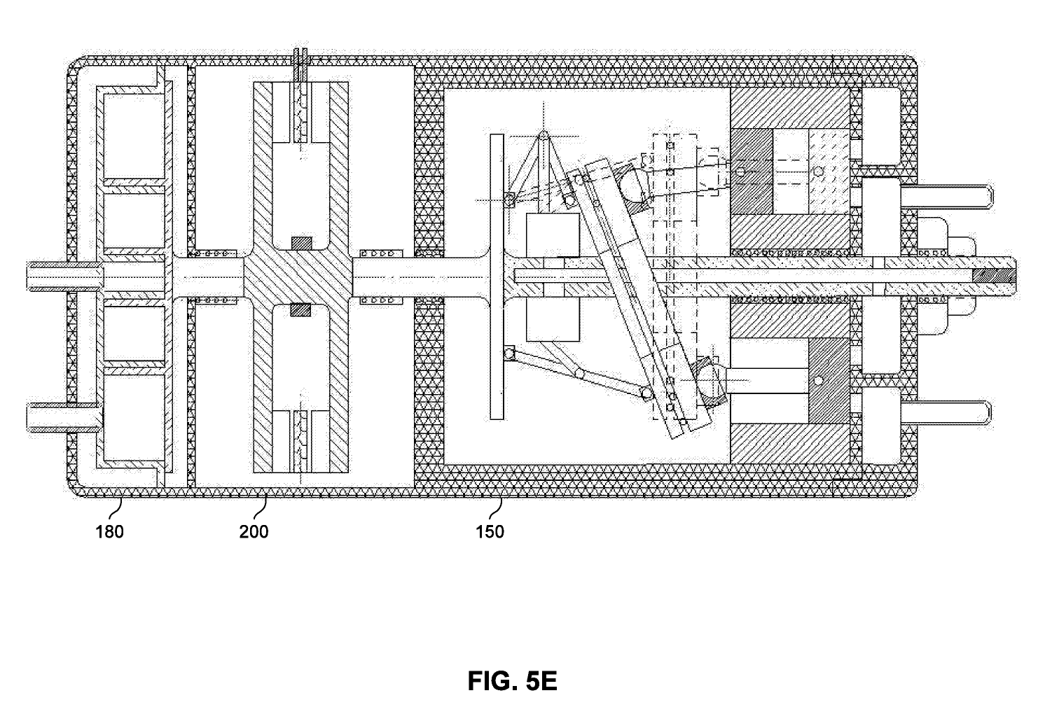

Angular velocity sensor 112 may be implemented, for example, by a rotational encoder which generates a pulse with each revolution of expander 116. Alternatively, angular velocity sensor 112 may be implemented as an optical encoder a magnetic encoder (e.g., Hall effect encoder), an inertial encoder (e.g., an Inertial Measurement Unit—IMU) or a capacitive encoder. Angular velocity sensor 112 may be a wireless sensor wirelessly coupled with controller 111. Mechanical coupler 108 may be implemented as a variable torque divider gear. Alternatively, mechanical coupler 108 may be an interconnecting shaft or shafts as further described below in conjunction with FIG. 5E. Variable flow compressor 122 may be any kind of mechanical variable flow compressor or mechanical variable flow pump or plurality of compressors or pumps in which the flow of vapors or liquid there through may be controlled while the angular velocity thereof is constant. Generator/motor 106 (e.g., an alternator) is operative for converting electrical power into mechanical power and for converting mechanical power into electrical power. Alternatively, generator/motor 106 may be implemented as a motor and generator separate from each other and separately coupled to mechanical coupler 108. Also, distributor 113 may elements such as power switches, power regulators, power converters and transformers.

When heat-pump 104 is employed for cooling, the suction port of variable compressor 122 is coupled with evaporator 124 and the discharge port of variable port compressor 122 is coupled with condenser 118 (e.g. via a four way valve—not shown). Heat-source 128 (e.g., solar panels, waste heat, burning fuel or gas) provides heat to Boiler 114. Boiler 114 generates high pressure vapors from a motive liquid such as an organic refrigerant fluid. The vapors expand through expander 116 which rotates at an angular velocity and generates mechanical rotation power. This power is provided to variable flow compressor 122 via mechanical coupler 108. The vapors exit expander 116 at lower pressure vapors and enter into condenser 118. Condenser 118 transfers heat from the vapors to the surroundings and condenses the vapors into motive liquid at the saturation temperature and pressure. The motive liquid exits condenser 118 to both pump 120 and expansion valve 126. Pump 120 pumps the motive liquid back to boiler 114. The operation of pump 120 is determined by pressure in sensing bulb 115. The pressure in sensing bulb 115 is determined according to the temperature of the vapors exiting boiler 114.

The liquid provided to expansion valve 126 expands there through to form a lower pressure fluid that enters evaporator 124. Evaporator 124 absorbs heat from the environment to be cooled (e.g., a room a building) and evaporates the liquid. The vapors exit evaporator 124 by the suction generated by variable flow compressor 122 and enter variable flow compressor 122 through the suction port thereof. Variable flow compressor 122 compresses the refrigerant to a higher pressure, which also results in an increase in the temperature of the refrigerant vapors. Variable flow compressor 122 discharges the vapors back to condenser 118 through the discharge port thereof. Thus, along with the vapors from expander 116, two close parallel cycles are formed, a power cycle and a heat-pump cycle.

As mentioned above mechanical coupler 108 mechanically couples expander 116, variable flow compressor 122 and generator/motor 110 such that mechanical power is transferred therebetween. According to the disclosed technique, generator/motor 106 operates as an electrical power generator when the power generated by expander 116 is larger than the power required by heat pump 104 to meet the heating or cooling requirements. Conversely, generator/motor 106 operates as an electric motor (i.e., produces mechanical power) when the power generated by expander 116 is smaller than the power required by heat pump 104 to meet the heating or cooling requirement.

In general, the sum of the absolute value of the power expended by variable flow compressor 122, generator/motor 110 and power losses, should be balanced with the absolute power generated by expander 116 as follows:

P_{expander}=P_{compressor}+P_{generator/motor}+P_{glosses} (1)

where, in equation (1), P_{expander} represents the absolute value of the power generated by expander 116, P_{generator/motor} represents the absolute value of the power (i.e., either mechanical or electrical) generated or generator/motor 106, P_{compressor} represents the absolute value of the power expended by variable flow compressor 106 and Pₗₒₛₛₑₛ represent the absolute value of the power losses (i.e., friction). The power expended by generator/motor 106, P_{generator/motor} is referred to herein as positive when generator/motor 106 operates as an electric power generator and as negative when generator/motor 106 operates as an electric motor (i.e., as a mechanical power generator). Power controller 110 controls the power generated by generator/motor 106 and the sign thereof, such that equation (1) is satisfied (i.e., the power balance is maintained), and the angular velocity of each of expander 116, generator/motor 106 and compressor 122 is maintained constant, for example, relative to a determined reference operational angular velocity. In other words, controller 110 equilibrates the angular velocities of expander 116, generator/motor 106 and compressor 122 by controlling the power level and direction thereof generated by generator/motor 106, such that these angular velocities are maintained constant relative to a reference operational angular velocity. Each one of expander 116, generator/motor 106 and compressor 122 is thus associated with a respective operational angular velocity, which related to the reference operational angular velocity according to the gear ratios of mechanical coupler 108. Since, as mentioned above, power is related to the torque time the angular velocity, equation (1) may also be interpreted as a torque balance between expander 116, generator/motor 106, compressor 122 and the losses.

For the purpose of the following explanation of the disclosed technique, it is assumed that that RC 102 is providing exactly the power required by heat pump 104 to meet the heating or cooling requirements thereof. In other words, all the power generated by RC 102 is employed by heat pump 104 and thus, generator/motor 106 does not generate power (i.e., either mechanical or electrical) and P_{generator/motor} is substantially zero. This state is referred to herein as ‘the balanced state’ of system 100. Furthermore, expander 166, compressor 122 and generator/motor 106 rotate at the respective operational angular velocities thereof.

When the heating or cooling requirements of heat pump 104 decrease, the flow rate and suction pressure of variable flow compressor 122 also reduces (i.e., in accordance with the internal variable flow control of variable flow compressor 122), thus decreasing the power required by variable flow compressor 122 to satisfy these decreased heating or cooling requirements. Consequently, the power generated by RC 102 is larger than the power required by heat pump 104. This state is referred to herein as ‘the positive state’. The reduction in the power required to satisfy the reduced heating or cooling requirements results in a temporary reduction of the opposing torque generated by variable flow compressor 122. This reduction of opposing toque results in a temporary increase in the angular velocity (i.e., acceleration) of mechanical coupler 108 and thus, in the angular velocity of expander 116 coupled thereto. Angular velocity sensor 116 senses the change of the angular velocity and indicates to controller 111 that the angular velocity of expander 116 increased. Controller 111 then directs generator/motor 106 to generate electrical power, thus exerting opposing torque on expender 116, which counters the excess torque generated by RC 102, such that the angular velocity of expander 116 reduces back to the respective operational angular velocity thereof. Accordingly, the respective operational angular velocity of expander 116 and thus, operational velocities of compressor 122 and generator/motor 106, as well as the power balance, are maintained. Generator/motor 106 provides the electric power generated thereby to power distributor 113. Controller 111 directs power distributor 113 to distribute the power to at least one of the system modules 130, energy storage 132 or grid 134. With reference to FIG. 3B, the thick arrows 136A-136I depict the flow of power in system 100, when the power required by heat pump 104 to satisfy the cooling requirements is less than the power generated by RC 102 and generator/motor 106 generates electric power. In the example brought forth in FIG. 3B, distributor 113 provides the electric power generated by generator/motor 106, for example, first to the system modules 130, then to an energy storage 132 and then to the power grid 134. Thus, in the positive state, the system is self-sustained. It is, however, noted that, in the positive state, the priorities by which the electric power generated by generator/motor 106 is provided may differ from the priorities described above. For example, distributor 113 provides the electric power generated by generator/motor 106, first to energy storage 132, then to system modules 130 and then the power grid 134 or any set of priorities.

When the heating or cooling requirements of heat pump 104 increase, the flow rate and suction pressure of variable flow compressor 122 also increases, (i.e., in accordance with the internal variable flow control of variable flow compressor 122), thus increasing the power required by variable flow compressor 122 to satisfy this increase in the heating or cooling requirements. Consequently, the power generate by RC 102 is smaller than required by heat pump 104. This state is referred to herein as ‘the negative state’. The increase in the power required to satisfy the increased cooling requirements results in a temporary increase of the opposing torque generated by variable flow compressor 122. This increase in opposing torque results in a temporary decrease in the angular velocity (i.e., deceleration) of mechanical coupler 108 and in the angular velocity of expander 116 coupled thereto. Angular velocity sensor 116 senses the change of the angular velocity and indicates to controller 111 that the angular velocity of expander 116 decreased. Controller 111 then directs generator/motor 106 to generate mechanical power (i.e., operate as an electrical motor) and directs power distributer 113 to couple generator/motor 106 to energy storage 132 or grid 134 from which generator/motor 106 shall receive the required electrical power. In other words, either energy storage 132 or grid 134 shall provide generator/motor 106 the electrical power required thereby. Thus, generator/motor 106 supplements the power generated by RC 102, such that the angular velocity of expander 116 increases back to the respective operational angular velocity thereof. Accordingly, the operational angular velocity of expander 116 and thus the operational velocities of compressor 122 and generator/motor 106, as well as the power balance are maintained. With reference to FIG. 3C, the thick arrows 138A-138I depict the flow of power in system 100 when the power required by heat pump 104 to satisfy the heating or cooling requirements is larger than the power generated by RC 102 and generator/motor 106 generates mechanical power. As depicted in FIG. 3C, generator/motor 106 employs electric power from either energy storage 132 or gird 134 to produce mechanical power which supplements the power generated by RC 102.

When RC 102 does not generate power, generator/motor 106 shall generate the power required by heat pump 104 to meet the heating or cooling requirements thereof employing power from either grid 134 or energy storage 132. With reference to FIG. 3D, the thick arrows 140A-140F depict the flow of power when RC 102 does not generate power.

It is noted that the various modules in system modules 130 receive the power required thereby from distributor 113. The power source providing the power to system modules may be any one of generator/motor 106, energy storage 132 or grid 134. It is further noted that energy storage 132 and grid 134 are optional supplementary power sources or power loads. For example, it would not always be possible to install an energy storage nor to couple the system to a grid.

The description above relating to the operation of system 100 relative to the balanced stated is brought herein for the purpose of explanation only. In general, after the onset of operation of system 100, expander 116, compressor 122, and generator/motor rotate at the respective operational angular velocities thereof, which are related to a reference operational angular velocity according to the gear ratios of mechanical coupler 108. The reference operational angular velocity is typically determined according to expected maximum cooling requirements and according to various operational parameters of expander 116 and compressor 122 (e.g., maximum operating temperature, pressure and angular velocity, maximum flow capacity and the like) and generator/motor 116. However, this reference operational angular velocity may be dynamically adjusted for example, when the detected angular velocity of expander 116 increases above or decreased below the operational angular velocity of expander 116 by a predetermined value for pre-determined a period of time (e.g., when the pressure in boiler 114 increases or decreases due to a change in temperature of heat source 128).

Further after the onset of operation, system 100 may be in any one of the balanced state (i.e., in heating or cooling mode), positive state or negative state and angular velocity sensor 112 provides information relating to the angular velocity of expander 116. Controller 111 determines the angular velocity of expander 116. When system 100 is in the positive state, and the angular velocity of expander 116 increases (e.g., either due to a decrease in the heating or cooling requirements or due to an increase in the mechanical power generated by RC 102), controller 111 directs generator/motor 106 to increase the electric power generated thereby such that the angular velocity of expander 116, decreases back to the respective operational velocity thereof and the power balance is restored. When system 100 is in the positive state, and the angular velocity of expander 116 decreases (e.g., either due to an increase in the heating or cooling requirements or due to a decrease in the power generated by RC 102), controller 111 directs generator/motor to reduce the electric power generated thereby, such that the angular velocity of expander 116 decreases back to the respective operational velocity thereof and the power balance is restored. When system 100 is in the negative state, and the angular velocity of expander 116 decreases, controller 111 directs generator/motor to increase the mechanical power generated thereby such that the angular velocity of expander 116 increases back to the respective operational velocity thereof and the power balance is restored. When system 100 is in the negative state, and the angular velocity of expander 116 increases, controller 111 directs generator/motor to decrease the mechanical power generated thereby such that the angular velocity of expander 116 increases back to the respective operational velocity thereof and the power balance is restored.

At the onset of operation of system 100, the temperature of heats source 128 (e.g., the sun, burning material) rises to a preset temperature. As the temperature of heat source 128 approaches this preset temperature, pump 120 is activated to charge boiler 114 with liquid. Boiler 114 starts producing vapors and the pressure rises to follow the appropriate boiling saturation temperatures. As vapors pressure rises, vapors start flowing into expander 116. Expander 116 starts rotating and generating power. Being mechanically coupled with Expander 116, variable flow compressor 122 and generator/Motor 106 start rotating as well, producing a power balance, generator/Motor 106 by generating electric power and variable flow compressor 122 by increasing vapors flow there through. As the flow through variable flow compressor 122 increases to meet the required heating or cooling requirements, controller 111 directs generator/motor 106 to reduce the power generated thereby to maintain the power balance until expander 116 reaches the respective operational velocity thereof. Thereafter, controller 111 directs generator/motor so as to maintain the power balance and the operational velocities as described above.

The description above with regards to the operation of system 100 relates to the situation when heat pump 104 is employed for both cooling and heating. Nevertheless, following is a description of system 100 when heat pump 104 is employed for heating.

With reference to FIG. 3E, when heat pump 104 is employed for heating, the suction port of variable flow compressor 122 is coupled with condenser 118 and the discharge port of variable flow compressor 122 is coupled with evaporator 124 (e.g. also via the above mentioned four way valve or by reversing the direction of flow within variable flow compressor 122). When heat pump 104 is employed for heating, the pressure in condenser 118 is low due to the low environmental temperature. When heat source 128 is available, Rankine cycle 102 is active and expander 116 generates power into mechanical coupler 108. However, heat pump 104 operates in a reverse (i.e., heating) mode. Therefore, the pressure in evaporator 124 is now higher than the pressure in condenser 118. Thus, vapors existing expander 116 enter into the suction port of variable flow compressor 122 at a flow rate determined by the heating requirements of the heated site. Variable flow compressor 122 compresses the vapors and discharges the compressed vapors to evaporator 124. Evaporator 124 transfers the heat of the vapors to the heated site and liquefies the vapors. The liquid flashes through expansion valve 126 to the inlet of pump 120, which is at same pressure as condenser 118. When more vapors are available from expander 116 than required by variable flow compressor 122, the excess vapors enter condenser 118, liquefy due to the low environment temperature, exit to pump 120 and are mixed with the liquied from evaporator 124.

When heat source 128 is not available, pump 120 is not active and no vapors flow through expander 116. Controller 111 then activates Generator/motor 106 to generate mechanical power so as to operate variable flow compressor 122 and drive heat pump 104.

When heat source 128 is available but is not sufficient to operate RC 102, generator/motor 106 drive heat pump 104. However, the temperature of the vapors entering variable flow compressor 122 is higher than the temperature of the environment. Thus, the heat released to the heated site results from the energy provided by heat source 128 and generator/motor 106. It is noted that the above description relating to the maintaining of the power balance and the operational velocities is applicable also when heat pump 104 is employed for heating.

It is noted that in the description above in conjunction with FIGS. 3A-3E, angular velocity sensor 112, sensing the angular velocity of expander 116 was brought forth as an example only. Angular velocity sensor 112 may sense the angular velocity of any one of expander 116, compressor 122 or generator/motor 106 or of a tooth wheel in mechanical coupler 108. Alternatively, angular velocity sensor 112 may be replaced with a torque sensor sensing the torque of any one of one of expander 116, compressor 122 or generator/motor 106 or of a tooth wheel in mechanical coupler 108.

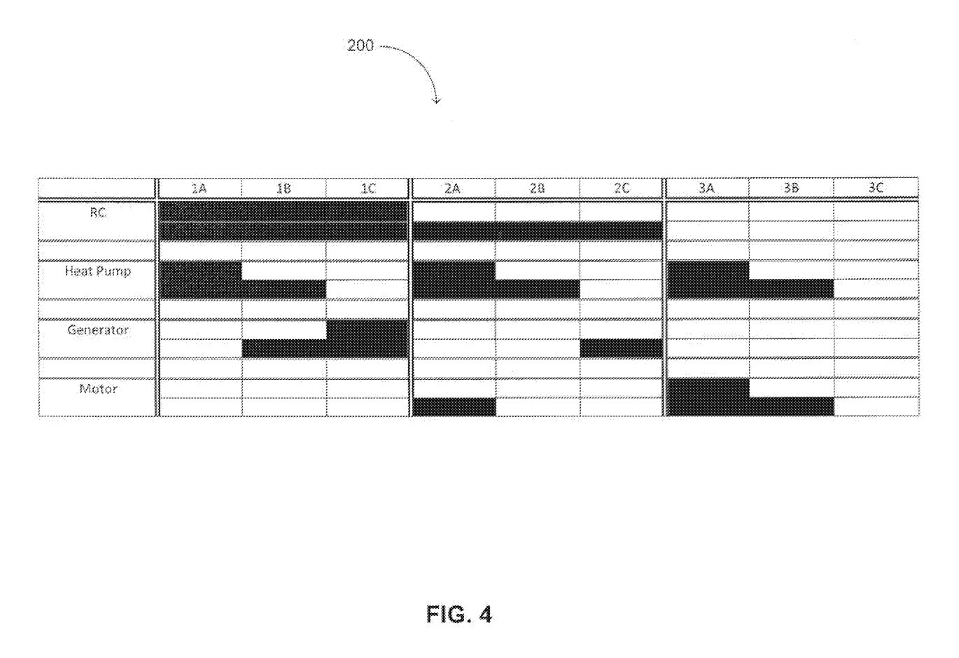

Reference is now made to FIG. 4, which is a schematic illustration of a table, generally referenced 200, depicting an exemplary logic by which a system according to the disclosed technique may operate, in accordance with another embodiment of the disclosed technique. Table 200 depicts three operational states of the RC, state ‘1’ state ‘2’ and state ‘3’. State ‘1’ relates to the RC operating at full power generation capacity. State ‘2’ relates to the RC operating at partial power generation capacity and State ‘3’ relates to the RC generating no power. Each state of the RC is associated a state of the heat pump, state ‘A’, state ‘B’ and state ‘C’. State ‘A’ relates to the heat pump operating at full capacity, state ‘B’ relates to heat pump operating at partial capacity and state ‘C’ relates to the heat pump being at a non-operational state. The rows relating to Generator depict the level of electric power generated by the generator/motor (i.e., the generator motor operates as electric generator). The rows relating to Motor the level of mechanical power generated by the generator/motor (i.e., the generator motor operates as electric motor). As depicted in FIG. 4, at state 1B, 1C and 2C generator/motor operates as an electric power generator generating electrical power. At state 1C, generator/motor generates electric power at full capacity. At states 1B and 2C generator/motor generates electrical power at partial capacity. At state 2A, 3A and 3B generator/motor operates as a mechanical power generator. At state 3A generator/motor generates mechanical power at full capacity. At states 2A and 3B generator/motor operates and generates power at partial capacity. At states 1A, 2B and 3C generator/motor does not generate power.

As mentioned above, the expander, the generator/motor and the compressor may all be mechanically coupled such that they share a single common rotational shaft. Reference is now made to FIGS. 5A-5E which are schematic illustrations of a variable flow compressor 150, an expander 180 and a generator motor 200, integrated and mechanically coupled such that they share a single common rotational shaft, in accordance with a further embodiment of the disclosed technique.

FIG. 5A, depicts an exemplary variable flow compressor 150, which includes a shaft 152 a rotating plate 154 also referred to as swashplate 154, a non-rotating plate 156 and pistons 158. The inclination angle of swashplate 152 relative to the shaft 152 is adjustable. Pistons 158 are in contact with a non-rotating plate 156 via rods 160 and are also movable within bores 162. Also, discharge and suction check-valves (not shown) are located in each of bores 162. Swashplate 154 is in slidable contact with non-rotating plate 156. Swashplate 154 is employed to translate rotational motion into reciprocating motion of pistons 158.

As swashplate 154 slides over non-rotating plate 156, pistons 158 are forced by rods 160 to move through bores 162 and transfer fluid between the compressor suction port 164 and discharge port 166. The angle of swashplate 154 is controlled by a pressure activator 168, which is fed by measured suction fluid in a through bore in shaft 152. The suction pressure is determined by the refrigerant fluid saturation temperature, which is related to the required temperature in the heated or cooled space. Pressure activator 168 is counter-balanced by similar pressure activator 170 that holds swashplate 152. When the suction pressure reduces, the angle of swashplate 154 relative to shaft 152 approaches perpendicularity, thereby reducing the piston stroke length and thus, the amount of fluid flowing through compressor 150. When suction pressure increases, the angle of swashplate 154 relative to shaft 152 becomes more acute, thereby increasing the piston stroke length and thus, the amount of fluid flowing through compressor 150.

FIGS. 5B and 5C depict expander 180. FIG. 5B is a front view of expander 180 and FIG. 5C is a side cross-section of expander 180. Expander 180 includes scroll 182 and scroll 184 which form right-hand and left-hand components. One scroll is phased 180 degrees with respect to the other to allow the scrolls to mesh along line 186. This creates crescent shaped gas pockets, bounded by the involutes and base plates of both scrolls. In operation, scroll 182 remains fixed while the scroll 184 is attached to an eccentric rotating shaft. As the scroll 184 rotates eccentric relative to the scroll 182, the tiny pockets formed by the meshed scrolls at the center follow the spiral outward and become larger in size. The expander inlet is at the center 188. The entering gas is trapped in two diametrically opposed gas pockets and expands as the pockets move toward the periphery, where the discharge port 190 is located. No valves are needed, which reduces noise and improves the durability of the unit.

FIG. 5D depicts a generator/motor 200 operable to generate either electrical power of mechanical power. Generator/motor 200 includes a stator ring 204 which includes a stationary set of wire coil windings, outside which a rotor 202 revolves. Rotor 202 is an electromagnet. When generator/motor 200 generates electrical power, rotor 202 supplied with electricity through carbon or copper-carbon brushes in contact with two revolving metal slip rings 206 on shaft 152. The rotation of the electromagnet outside the stator coils generates alternating electricity inside these coils. The electricity flows through contacts 208. To regulate the power generated by generator/motor 200 regardless of the angular velocity of shaft 152, the current supplied to the electromagnet is controlled, and the torque which is required to rotate the rotor 202 changes accordingly. FIG. 5E depicts variable flow compressor 150, an expander 180 and a generator motor 200, mechanically coupled such that they share a single common rotational shaft.

It is noted that the embodiment of variable flow compressor 150, expander 180 and generator/motor 220 described hereinabove in conjunction with FIGS. 5A-5E relate to one exemplary embodiment a variable flow compressor, expander or generator/motor, which may be employed in a system according to the disclosed technique. Expander 180 may be embodied as turbine expander, gear expander, swashplate and wobble plate pistons expander, rotary vane expander and others. Variable flow compressor 150 may be embodied as a swash-plate or wobble plate compressor with rotating or axial non-rotating pistons.

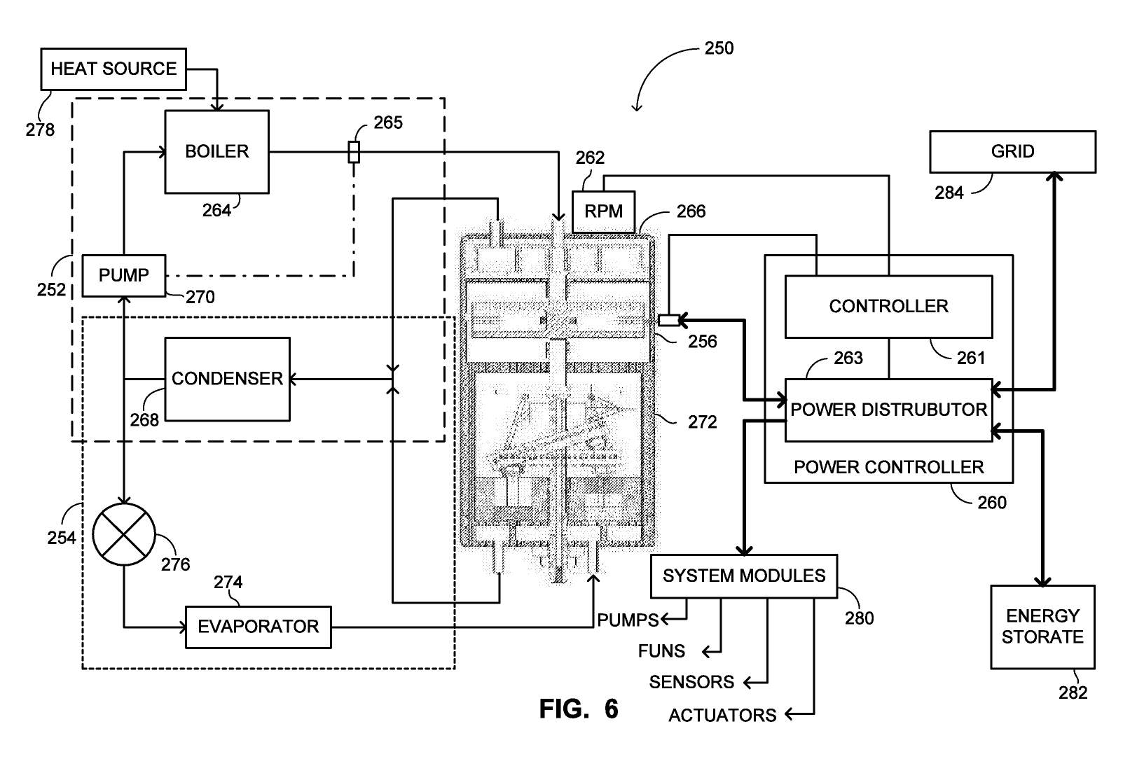

Reference is now made to FIG. 6, which is a schematic illustration of a system, generally referenced 250, for dynamic mechanical power management, constructed and operative in accordance with another embodiment of the disclosed technique. System 250 includes an RC 252, a heat pump 254, a generator/motor 256, a power controller 260, an angular velocity sensor 262 (demarked ‘RPM’ in FIG. 6) and a sensing bulb 265. RC 252 includes a boiler 264, an expander 266, a condenser 268 and a pump 270. Heat pump 254 includes condenser 268 (i.e., condenser 268 is common to both RC 252 and heat pump 254), a variable flow compressor 272, an evaporator 274 and an expansion valve 276. Power controller 260 includes a controller 261 and a power distributor 263.

In RC 252, expander 266 is fluidally coupled with boiler 264 and with condenser 268 (e.g., via pipes or conduits in which a fluid can flow). Pump 270 is fluidally coupled with condenser 268 and with boiler 264 (e.g., also via pipes or conduits in which a fluid can flow). In heat pump 254, condenser 268 is fluidally coupled with variable flow compressor 272 and expansion valve 276. Evaporator 274 is also fluidally coupled with variable flow compressor 272 and expansion valve 276. Furthermore in system 250, expander 266, variable flow compressor 272 and generator/motor 256 are mechanically coupled therebetween such that they share a single common rotational shaft and such that mechanical power is transferred therebetween. Furthermore, controller 261 is coupled with generator/motor 256, with angular velocity sensor 262 and with power distributor 263. Sensing bulb 265 is coupled with pump 270. Power distributor 263 is electrically coupled with generator motor 256, system modules 280, energy storage 282 and electric grid 284. The operation of system 250 is similar to the operation of system 100 described hereinabove in conjunction with FIGS. 3A-3E.

It will be appreciated by persons skilled in the art that the disclosed technique is not limited to what has been particularly shown and described hereinabove. Rather the scope of the disclosed technique is defined only by the claims, which follow.

1. A power management system comprising:
a mechanical power source generating torque;
a variable mechanical power load, mechanically coupled with said mechanical power source such that torque is transferred between said mechanical power source and variable mechanical power load;
a generator/motor, mechanically coupled with said mechanical power source and said variable mechanical power load such that torque is transferred between said mechanical power source, said mechanical power load and said generator/motor, said generator/motor being operative to operate as a mechanical power generator converting electrical power into mechanical power, and an electric power generator converting mechanical power into electrical power; and
a power controller, coupled with said mechanical power source and with said generator/motor, said power controller directing said generator/motor to operate as one of a mechanical power generator and an electrical power generator, to maintain a power balance between said mechanical power source, said variable mechanical power load and said generator/motor, such that the angular velocity of each of said mechanical power source, said variable mechanical power load and said generator/motor is maintained at their respective operational velocities.

2. The system according to claim 1, wherein said controller directs said generator/motor to convert electrical power into mechanical power when one of the following occurs:
the power generated by said power source decreases; and
the power expended by said variable mechanical power load increases.

3. The system according to claim 1, wherein said controller directs said generator/motor to convert mechanical power into electrical power when one of the following occurs:
the power generated by said power source increases; and
the power expended by said variable mechanical power load decreases.

4. The system according to claim 1, wherein said mechanical power source is a Rankine cycle and said variable power load is a heat pump,
wherein said Rankine cycle includes:
a boiler for heating a fluid and generating high pressure vapors therefrom;
an expander, fluidally coupled with said boiler and mechanically coupled with said generator motor, said expander rotating when said vapors expand there through;
a condenser, fluidally coupled with said expander for condensing said vapors exiting from said expander; and
a pump, fluidally coupled with said condenser and with said boiler for pumping said fluid from said condenser back into said boiler; and
wherein said heat pump includes:
an expansion valve, fluidally coupled with said condenser for forming a liquid;
an evaporator, fluidally coupled with said expansion valve for evaporating the liquid provided from said expansion valve; and
a variable flow compressor, fluidally coupled with said evaporator and with said condenser and mechanically coupled with said generator motor for compressing said liquid to a higher pressure, said variable flow compressor providing said liquid to said condenser.

5. The system according to claim 4, wherein said expander, said generator/motor and said variable flow compressor are all mechanically coupled such that they share a single common rotational shaft.

6. The system according to claim 4, further including a mechanical coupler,
wherein said expander, said generator motor and said variable flow compressor are all mechanically coupled via said mechanical coupler.

7. The system according to claim 4, further including a sensing bulb, coupled with said pump, the operation of pump is determined by pressure in said sensing bulb,
wherein the pressure in said sensing bulb is determined according to the temperature of the vapors exiting said boiler.

8. The system according to claim 1, further including an angular velocity sensor, coupled with said controller and mechanically coupled with one of said power source, power load, generator/motor for detecting a respective angular velocity thereof.

9. The system according to claim 1, wherein said power controller includes a controller coupled with a power distributor,
wherein, said controller directs said power distributor to couple said generator/motor at least with system modules when said generator/motor generates electrical power, such that said generator/motor provides electrical power to said system modules.

10. The system according to claim 8, wherein said controller further directs said power distributor to couple said generator/motor to at least one of a grid and power storage such that when said generator/motor generates electrical power such that said generator/motor provides electrical power to said least one of said grid and power storage.

11. The system according to claim 1, wherein said power distributor couples said generator/motor with at least one of a grid and a power storage when said generator/motor generates mechanical power such that at least one of said grid and said power storage provide electric power to said generator/motor.
